(19) United States
(12) Patent Application Publication
(10) Pub. No.: US 2025/0218707 A1
(43) Pub. Date: Jul. 3, 2025

(54) BUTTON MODULE AND PROJECTION DEVICE

(71) Applicant: Coretronic Corporation, Hsin-Chu (TW)

(72) Inventors: CHIEN-CHUNG LIAO, Hsin-Chu (TW); CHANG-YUNG CHEN, Hsin-Chu (TW); CHUN-HSIEN WU, Hsin-Chu (TW)

(21) Appl. No.: 19/001,629

(22) Filed: Dec. 26, 2024

(30) Foreign Application Priority Data
Dec. 28, 2023 (CN) 202323606395.3

(51) Int. Cl. H01H 13/14; G03B 21/14; H01H 13/10

(52) U.S. Cl. CPC H01H 13/14; G03B 21/145; H01H 13/10

(57) ABSTRACT

A button module includes a first electronic element, a pressing element, a second electronic element, and an operation element. The pressing element has a pressing part and a first actuation part. The pressing part has a through-hole. The pressing part moves relative to the first electronic element in a pressing direction. The pressing part drives the first actuation part to move when the pressing part moves so that the first actuation part actuates the first electronic element. The operation element has a driven part and a second actuation part. The second actuation part actuates the second electronic element. The driven part moves relative to the pressing part in an operation direction. The driven part drives the second actuation part to move when the driven part moves so that the second actuation part actuates the second electronic element. A projection device with the button module is also provided.

### CROSS-REFERENCE TO RELATED APPLICATION

This application claims the priority benefit of China application (No. 202323606395.3), filed on Dec. 28, 2023. The entirety of the above-mentioned patent application is hereby incorporated by reference herein and made a part of this specification.

### TECHNICAL FIELD

The disclosure relates to a touch-type actuation module, and more particularly to a button module and a projection device with the button module.

### BACKGROUND

Generally, most projection devices are equipped with touch buttons to trigger specific functions. For example, the projection devices usually have buttons (touch buttons) to turn on and turn off the power sources and startup function menus. In addition, some projection devices have knobs (touch buttons) to adjust the focal lengths of the projected images. However, in the prior art, the touch buttons with different actuation directions are still arranged independently. This not only occupies the internal space of the projection device but also causes the appearance of the projection device to be complex and inconvenient to operate. In addition, because the housing of the projection device must have many openings to accommodate the physical buttons, it also leads to a cumbersome and high-cost manufacture process for the projection device.

The information disclosed in this “BACKGROUND” section is only for enhancement understanding of the background and therefore it may contain information that does not form the prior art that is already known to a person of ordinary skill in the art. Furthermore, the information disclosed in this “BACKGROUND” section does not mean that one or more problems to be solved by one or more embodiments of the disclosure were acknowledged by a person of ordinary skill in the art.

### SUMMARY

The disclosure provides a button module, which reduces the space required for configuration and has the advantage of the easiness of operation.

The disclosure provides a projection device, which has the advantage of the easiness of operation and simplifies appearance and manufacturing procedure.

Other advantages and objectives of the disclosure may be further illustrated by the technical features broadly embodied and described as follows.

In order to achieve one or a portion of or all of the objectives or other objectives, the button module in one embodiment of the disclosure includes a first electronic element, a pressing element, a second electronic element, and an operation element. The pressing element has a pressing part and a first actuation part. The pressing part has a through-hole. The first electronic element and the second electronic element are disposed on a first side of the pressing part. The first actuation part is connected to the pressing part and protrudes from the pressing part to the first electronic element. The pressing part is configured to move relative to the first electronic element in a pressing direction. The pressing part drives the first actuation part to move when the pressing part moves, so that the first actuation part actuates the first electronic element. The operation element has a driven part and a second actuation part. The driven part extends from the through-hole toward a second side of the pressing part. The second side is an opposite side of the first side of the pressing part. The second actuation part is connected to the driven part and extends towards the first side of the pressing part. The second actuation part is connected to the second electronic element and is configured to actuate the second electronic element. The driven part is configured to move relative to the pressing part along the through-hole in an operation direction. The driven part drives the second actuation part to move when the driven part moves so that the second actuation part actuates the second electronic element. The operation direction is different from the pressing direction.

In order to achieve one or a portion of or all of the objectives or other objectives, the projection device in one embodiment of the present disclosure includes a housing, a processing unit, a projection module, and the aforementioned button module. The housing has an opening. The processing unit is disposed in the housing and is coupled to the button module. The processing unit generates an actuation signal when the pressing part of the pressing element is pressed. The projection module is disposed in the housing and is coupled to the processing unit. The projection module receives the actuation signal and projects a display picture onto a screen.

The button module in the present disclosure adopts a pressing element and an operation element, where the pressing element actuates the first electronic element in the pressing direction, and the operation element actuates the second electronic element in the operation direction. Specifically, the driven part of the operation element protrudes from the pressing part instead of being separated from the pressing part. Therefore, with regard to the present disclosure, the space required for the configuration of the button module can be greatly reduced, and the convenience in the operation of the button module can be improved. The projection device in the present disclosure has the advantage of the easiness of operation by adopting the button module. In addition, the projection device in the present disclosure has a simplified appearance and manufacturing procedure.

Other objectives, features and advantages of the disclosure will be further understood from the further technological features disclosed by the embodiments of the disclosure wherein there are shown and described preferred embodiments of this disclosure, simply by way of illustration of modes best suited to carry out the disclosure.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a three-dimensional schematic diagram of a button module in one embodiment of the disclosure;

FIG. 2 is a cross-sectional view of the button module in FIG. 1;

FIG. 3 is a schematic diagram of a pressing element in FIG. 2 moving in a pressing direction;

FIG. 4 is a top view of a first surface of a pressing part in FIG. 1;

FIG. 5 is a top view of a second surface of the pressing part in FIG. 1;

FIG. 6 is a cross-sectional view of a button module in another embodiment of the present disclosure;

FIG. 7 is a top view of a surface of a substrate in FIG. 6;

FIG. 8 is a cross-sectional view of a button module in another embodiment of the present disclosure;

FIG. 9 is a top view of a surface of a substrate in FIG. 8;

FIG. 10 is a schematic diagram of a projection device in one embodiment of the present disclosure; and

FIG. 11 is a block diagram of the projection device in FIG. 10.

### DETAILED DESCRIPTION OF PREFERRED EMBODIMENTS

In the following detailed description of the preferred embodiments, reference is made to the accompanying drawings which form a part hereof, and in which is shown by way of illustration specific embodiments in which the disclosure may be practiced. In this regard, directional terminology, such as “top”, “bottom”, “front”, “back”, etc., is used with reference to the orientation of the Figure(s) being described. The components of the disclosure can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the disclosure. Also, it is to be understood that the phraseology and terminology used herein are for the purpose of description and should not be regarded as limiting. The use of “including”, “comprising”, or “having” and variations thereof herein is meant to encompass the items listed thereafter and equivalents thereof as well as additional items. Unless limited otherwise, the terms “connected”, “coupled”, and “mounted” and variations thereof herein are used broadly and encompass direct and indirect connections, couplings, and mountings. Similarly, the terms “facing”, “faces”, and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

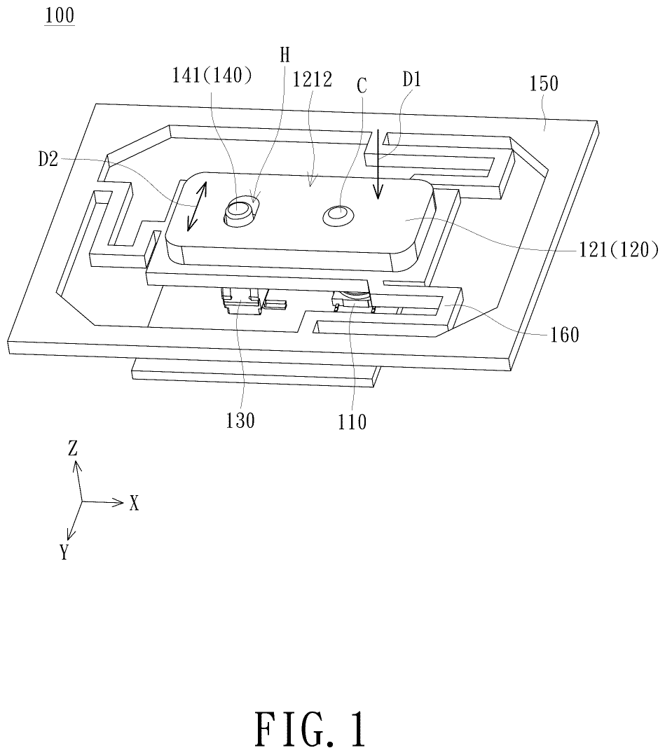

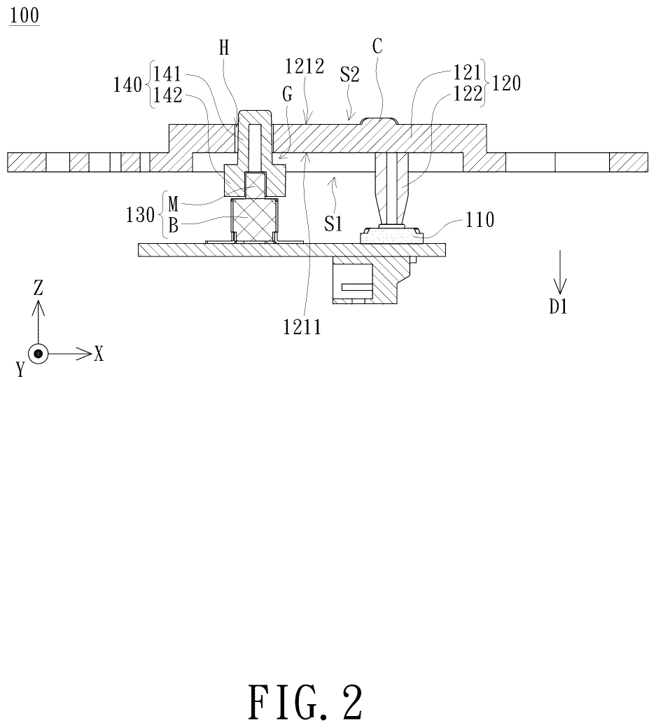

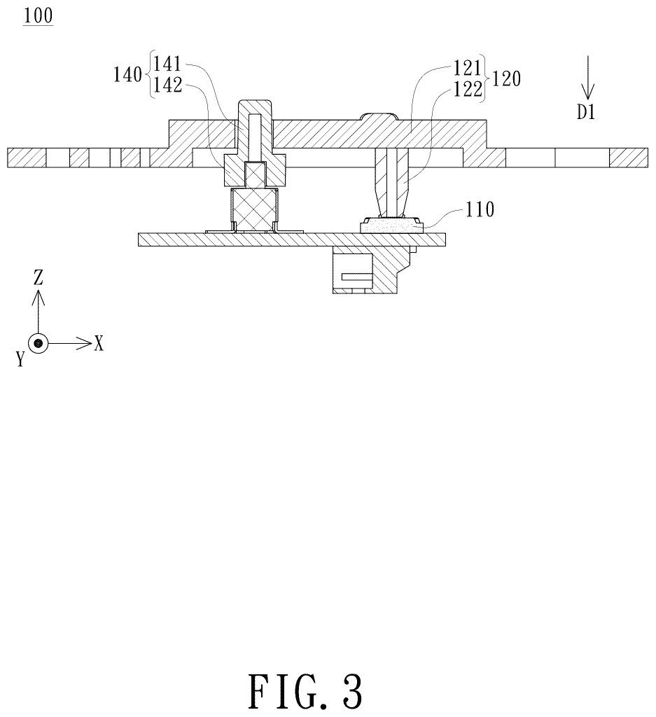

FIG. 1 is a three-dimensional schematic diagram of a button module in an embodiment of the disclosure. FIG. 2 is a cross-sectional view of the button module in FIG. 1. FIG. 3 is a schematic diagram of a pressing element in FIG. 2 moving in a pressing direction. Reference is made to FIG. 1 and FIG. 2 first. The button module 100 includes a first electronic element 110, a pressing element 120, a second electronic element 130, and an operation element 140. The pressing element 120 has a pressing part 121 and a first actuation part 122 (shown in FIG. 2). The pressing part 121 has a through-hole H. A first side S1 and a second side S2 are two opposite sides of the pressing part 121. The first electronic element 110 and the second electronic element 130 are disposed on the first side S1 (labeled in FIG. 2) of the pressing part 121. The first actuation part 122 is connected to the pressing part 121 and protrudes from the pressing part 121 toward the first electronic element 110. The pressing part 121 is adapted to move relative to the first electronic element 110 in a pressing direction D1. The pressing part 121 drives the first actuation part 122 to move when the pressing part 121 moves so that the first actuation part 122 actuates the first electronic element 110. The operation element 140 has a driven part 141 and a second actuation part 142. The driven part 141 protrudes from the through-hole H and extends away from the through-hole H toward the second side S2 of the pressing part 121. The second actuation part 142 is connected to the driven part 141 and extends towards the first side S1 of the pressing part 121. The second actuation part 142 is connected to the second electronic element 130 and is configured to actuate the second electronic element 130. The driven part 141 is adapted to move relative to the pressing part 121 along the through-hole H in an operation direction D2. The driven part 141 drives the second actuation part 142 to move when the driven part 141 moves, so that the second actuation part 142 actuates the second electronic element 130. The operation direction D2 is different from the pressing direction D1.

Reference is made to FIG. 2 and FIG. 3. The first electronic element 110 can be actuated after being pressed by the first actuation part 122, thereby triggering a corresponding function. The first electronic element 110 can include, for example, a dome switch, but other embodiments are not limited thereto.

In the present embodiment, the pressing part 121 of the pressing element 120 can be pressed by a user to drive the first actuation part 122 to actuate the first electronic element 110. Specifically, a force from the user can be applied to the pressing part 121 to make the pressing part 121 move in the pressing direction D1 to drive the first actuation part 122 to press the first electronic element 110 in the pressing direction D1, thereby actuating the first electronic element 110. The pressing direction D1 is, for example, substantially parallel to a Z-axis direction (for example, negative Z-direction), but the present disclosure is not limited thereto. In addition, in the present embodiment, when the pressure applied to the pressing part 121 is released, the pressing part 121 can drive the first actuation part 122 to return to the original position in a direction (for example, positive Z-axis direction) opposite to the pressing direction D1, thereby stop actuating the first electronic element 110. It can be understood that the first actuation part 122 can be aligned to the first electronic element 110 in the pressing direction D1, thereby facilitating a pressing of the first electronic element 110 in the pressing direction D1. In one embodiment, the pressing part 121 and the first actuation part 122 can have a monolithic structure, and the pressing part 121 and the first actuation part 122 can move simultaneously in the pressing direction D1 when the pressure is applied to the pressing part 121, and return to the original positions simultaneously. However, in another embodiment, the pressing part 121 and the first actuation part 122 can be separated structures, and the present disclosure is not limited thereto.

It is to be noted that in the present embodiment, the actuation of the pressing element 120 and the actuation of the operation element 140 are independent of each other and do not interfere with each other. Specifically, the width of the through-hole H in the direction parallel to the X-axis is greater than the width of the driven part 141 in the direction parallel to the X-axis (shown in FIG. 2) and the X-axis direction is perpendicular to the Z-axis direction. Thus, when the pressing part 121 drives the first actuation part 122 to move in the pressing direction D1 (parallel to the Z-axis direction), the operation element 140 can be static relative to the pressing part 121, thereby avoiding interference from the pressing part 121 and avoiding mistakenly activating the second electronic element 130. Thus, when the user presses the pressing part 121, the first electronic element 110 can be actuated, but the second electronic element 130 will not be actuated.

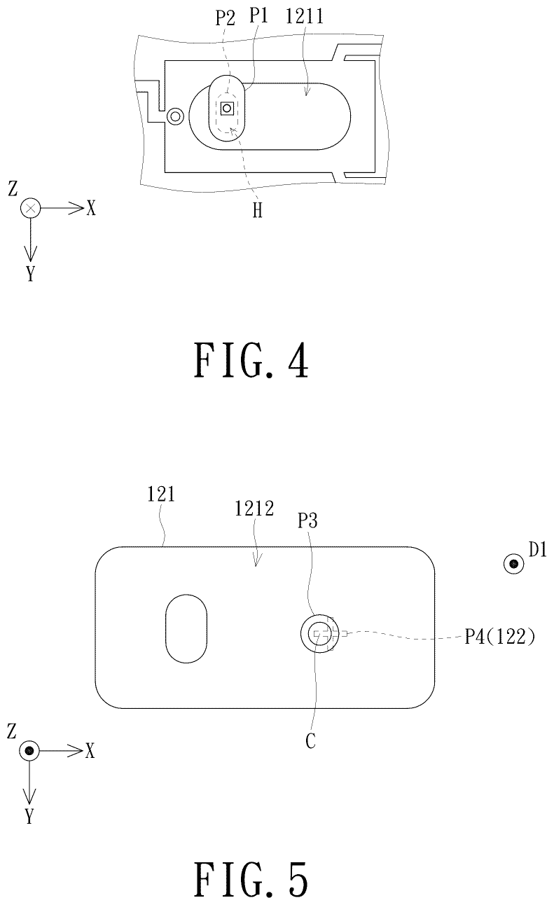

FIG. 4 is a top view of a first surface of the pressing part in FIG. 1. Reference is made to FIG. 2 and FIG. 4. Furthermore, the pressing part 121 may have a first surface 1211 and a second surface 1212. The first surface 1211 faces the first side S1, the second surface 1212 faces the second side S2, and the through-hole H penetrates the pressing part 121 from the first surface 1211 to the second surface 1212. The driven part 141 protrudes from the through-hole H and extends away from second surface 1212, and the second actuation part 142 is aligned to the through-hole H. The orthographic projection area P1 (shown in FIG. 4) of the second actuation part 142 on the first surface 1211 is larger than the orthographic projection area P2 (shown in FIG. 4) of the through-hole H on the first surface 1211, and there is a gap G (shown in FIG. 2) between the second actuation part 142 and the first surface 1211. The second actuation part 142 does not interfere with the pressing part 121 when the driven part 141 moves to drive the second actuation part 142 to move. In short, because the second actuation part 142 is spaced apart from the first surface 1211, the pressing part 121 pressing the second actuation part 142 when moving in the pressing direction D1 can be prevented. Thus, the second actuation part 142 interfering with the pressing part 121 can be prevented, and the movement stroke of the pressing part 121 can also be increased, thereby improving the pressing feel of the pressing part 121. Incidentally, the specific value of the gap G can be determined according to the actual needs, which is not limited in the present disclosure.

FIG. 5 is a top view of the second surface of the pressing part in FIG. 1. Reference is made to FIG. 1 and FIG. 2 again. The second surface 1212 in the present embodiment has, for example, a protruding part C, that is, the protruding part C protrudes from and relative to the second surface 1212, such that the user can feel the position of the pressing part 121 in case of poor vision. The protruding part C can be in a dot shape, but the present disclosure is not limited thereto. In addition, reference is made to FIG. 2 and FIG. 5. In the present embodiment, the orthographic projection area P3 (shown in FIG. 5) of the protruding part C on the second surface 1212 may at least partially overlap the orthographic projection area P4 (shown in FIG. 5) of the first actuation part 122 on the second surface 1212. In other words, the protruding part C and the first actuation part 122 can overlap each other in the pressing direction D1. For example, the orthographic projection area P3 in the present embodiment can overlap part of the orthographic projection P area 4, that is, the protruding part C can overlap part of the first actuation part 122 in the pressing direction D1. However, in one embodiment, the orthographic projection area P3 can be located within the orthographic projection area P4, that is, the protruding part C completely overlaps the first actuation part 122 in the pressing direction D1. Specifically, in the present embodiment, since the protruding part C can clearly present the position of the pressing part 121, the protruding part C may be more easily pressed compared to other parts of the pressing part 121. Based on the above, the position of the protruding part C can overlap the first actuation part 122 in the pressing direction D1, thereby improving the pressing feel of the pressing part 121. Incidentally, the protruding part C and the pressing part 121 can have a monolithic structure, which is not limited in the present disclosure.

Reference is made to FIG. 1 and FIG. 2 again. In the present embodiment, the driven part 141 of the operation element 140 can be pushed by an external force to drive the second actuation part 142 to move in the operation direction D2, so that the second actuation part 142 actuates the second electronic element 130. It is to be noted that when the driven part 141 moves along the through-hole H in the operation direction D2, the pressing part 121 can also be static relative to the driven part 141, thereby avoiding interference from the driven part 141 and avoiding mistakenly activating the first electronic element 110. Thus, when the user operates the driven part 141, the second actuation part 142 can be linked to actuate the second electronic element 130 without actuating the first electronic element 110. The driven part 141 and the second actuation part 142 in the present embodiment can have a monolithic structure, and the driven part 141 and the second actuation part 142 can move simultaneously in the operation direction D2 when the driven part 141 is pushed by the external force. However, in other embodiments, the driven part 141 and the second actuation part 142 can be formed by combining two elements. In the present embodiment, the driven part 141 can be in a rod shape, but the present disclosure is not limited thereto. It can be understood that the shape and actuation manner of the driven part 141 can be changed according to the actuation manner of the second electronic element 130, and thus this is not limited in the present disclosure. The operation direction D2 in the present embodiment is, for example, substantially parallel to the Y-axis direction, that is, the driven part 141 moves back and forth along the through-hole H in the positive Y-axis direction and the negative Y-axis direction, but the present disclosure is not limited thereto.

The second electronic element 130 can be driven by the second actuation part 142 to be actuated. For example, the second electronic element 130 in the present embodiment can include a slider switch. Specifically, the second electronic element 130 can have a base part B and a movable part M, where the movable part M extends from the base part B and is connected to the second actuation part 142. The movable part M can be driven by the second actuation part 142 to move relative to the base part B in the operation direction D2 to turn on or turn off the circuit disposed in the base part B. The base part B is, for example, fixed to a static plate. In addition, the second electronic element 130 includes, for example, a two-stage slider switch. However, in one embodiment, the second electronic element 130 can include a toggle switch, and thus this is not limited in the present disclosure.

Compared to the prior art, the button module 100 in the present embodiment adopts a pressing element 120 and an operation element 140, where the pressing element 120 actuates the first electronic element 110 in the pressing direction D1, and the operation element 140 actuates the second electronic element 130 in the operation direction D2. Furthermore, the driven part 141 of the operation element 140 protrudes from the pressing part 121 (the driven part 141 protrudes from the through-hole H and extends toward the second side S2 of the pressing part 121). Therefore, the present embodiment not only greatly reduces the space required for the button module 100 but also improves the convenience in the operation of the button module 100.

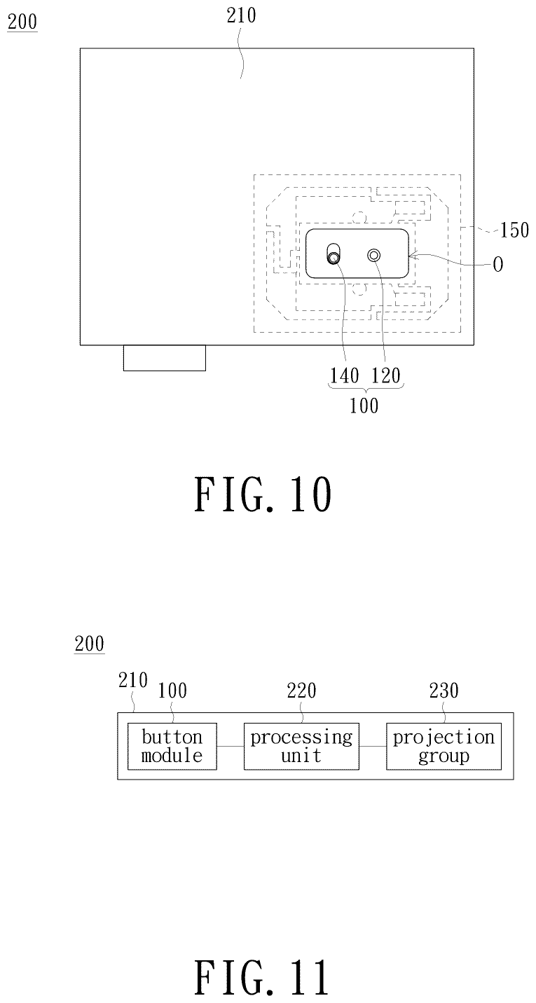

Reference is made to FIG. 1 continuously. Incidentally, the button module 100 may further include a frame body 150 and a rib part 160. The frame body 150 surrounds the pressing part 121. The frame body 150 is not linked with the pressing part 121 and does not move in conjunction with the pressing part 121 when the pressing part 121 moves. The two end parts of the rib part 160 are respectively connected to the frame body 150 and the pressing part 121. The pressing part 121 drives the first actuation part 122 to move relative to the frame body 150 when the pressing part 121 moves in the pressing direction D1. Specifically, the frame body 150 can be fixed to other elements (for example, a housing 210 in FIG. 10), and the rib part 160 can be slightly deformed with the pressure applied to the pressing part 121 when the pressing part 121 moves in the pressing direction D1, such that the pressing part 121 can move in the pressing direction D1. Similarly, the rib part 160 can drive the pressing part 121 to return to the original position when the pressure applied to the pressing part 121 is released. In the present embodiment, the frame body 150, the rib part 160, and the pressing part 121 can have, for example, a monolithic structure, but other embodiments are not limited thereto. In addition, the button module 100 in the present embodiment includes, for example, three rib parts 160, and the three rib parts 160 are respectively connected to the three different side edges of the pressing part 121, thereby achieving the stability of the pressing part 121 during movement, but the number of the rib parts 160 is not limited in the present disclosure.

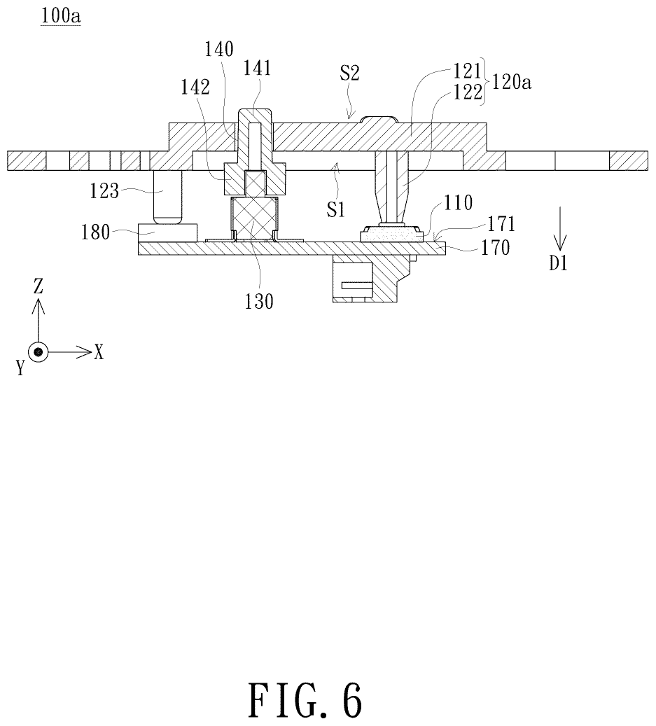

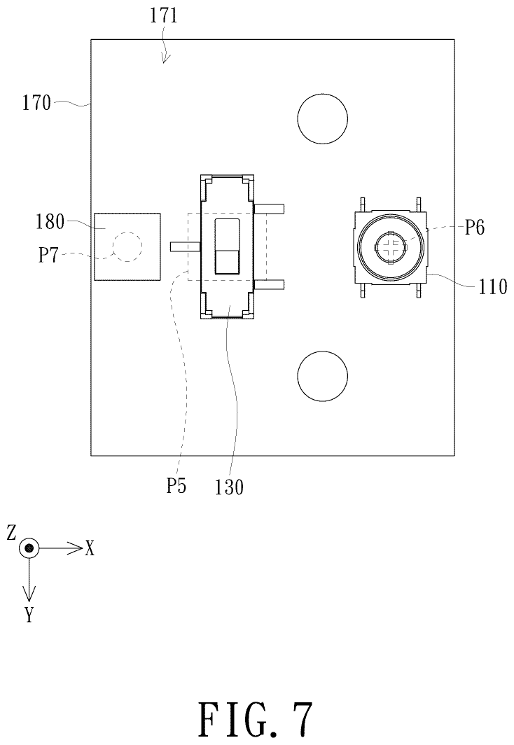

FIG. 6 is a cross-sectional view of a button module in another embodiment of the present disclosure. FIG. 7 is a top view of a surface of a substrate in FIG. 6. The structure and advantages of the button module 100a in the present embodiment are similar to those of the embodiment in FIG. 1, and only the differences are explained below. Reference is made to FIG. 6 first. The button module 100a can further include a substrate 170 and a buffer element 180. The substrate 170 is disposed on the first side S1 of the pressing part 121 and has a surface 171 facing the first actuation part 122 and the second actuation part 142. The first electronic element 110, the second electronic element 130, and the buffer element 180 are disposed on the surface 171. The pressing element 120a of the button module 100a can further include a support component 123. The support component 123 extends from the pressing part 121 to the buffer element 180 and abuts against the buffer element 180. Thus, the support component 123 can be supported between the buffer element 180 and the pressing part 121 when the pressing part 121 moves in the pressing direction D1, thereby further preventing the pressing part 121 from interfering with the second actuation part 142. Specifically, the buffer element 180 can be slightly deformed when being pressed by the support component 123, such that the pressing part 121 can move in the pressing direction D1 without interfering with the second actuation part 142. On the other hand, after the pressure applied to the pressing part 121 is released, the buffer element 180 can provide resilience to push the support component 123, such that the pressing element 120a returns to the original position in the positive Z-axis direction. In the present embodiment, the buffer element 180 can be a rubber element, but the present disclosure is not limited thereto. In addition, the buffer element 180 in the present embodiment can be in a block shape. In one embodiment, the support component 123 and the pressing part 121 can have a monolithic structure, and thus the support component 123 can be more stably supported between the buffer element 180 and the pressing part 121.

Reference is made to FIG. 6 and FIG. 7 together. On the surface 171 of the substrate 170, the second electronic element 130 is located between the first electronic element 110 and the buffer element 180. The orthographic projection area P5 of the second actuation part 142 of the operation element 140 on the surface 171 is located between the orthographic projection area P6 of the first actuation part 122 on the surface 171 and the orthographic projection area P7 of the support component 123 on the surface 171. In short, the second actuation part 142 is located between the first actuation part 122 and the support component 123 in the X-axis direction, such that the second actuation part 142 is closer to the support component 123 than the first actuation part 122. Thus, part of the movement stroke of the pressing part 121 towards the second actuation part 142 can be reduced when the pressing part 121 moves in the pressing direction D1, thereby the pressing part 121 interfering with the second actuation part 142 is further prevented. Incidentally, the first actuation part 122, the second actuation part 142, and the support component 123 are, for example, arranged along the negative X-axis direction. Similarly, the first electronic element 110, the second electronic element 130, and the buffer element 180 can be arranged along the negative X-axis direction, and the second electronic element 130 is located between the first electronic element 110 and the buffer element 180 in the X-axis direction. More specifically, in the pressing direction D1, the first actuation part 122 is aligned to the first electronic element 110, the second actuation part 142 is aligned to the second electronic element 130, and the support component 123 is aligned to the buffer element 180.

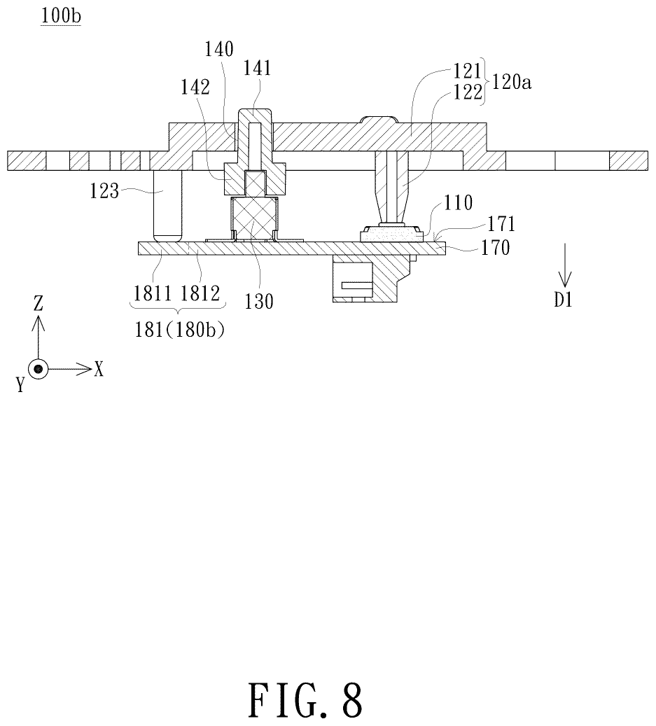

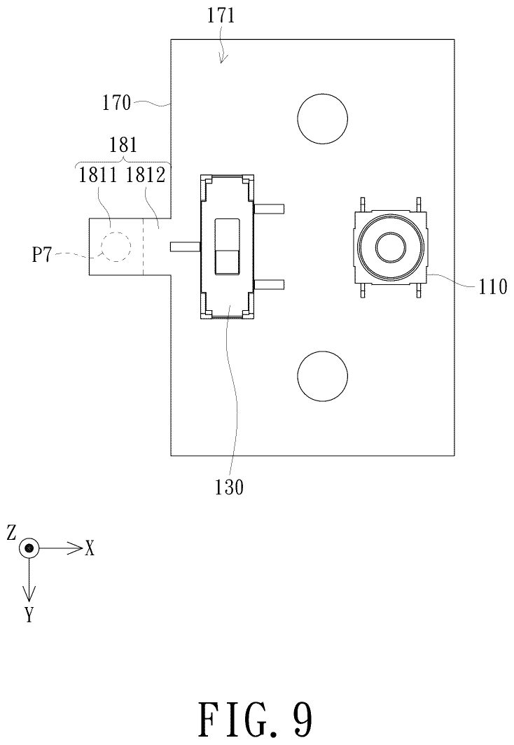

FIG. 8 is a cross-sectional view of a button module in another embodiment of the present disclosure. FIG. 9 is a top view of a surface of a substrate in FIG. 8. The structure and advantages of the button module 100b in the present embodiment are similar to those of the embodiment in FIG. 6, and only the differences are explained below. Reference is made to FIG. 8. The buffer element 180b is, for example, a cantilever element 181. The cantilever element 181 has a pressed section 1811 and an elastic section 1812 connected to each other. The elastic section 1812 is connected to the substrate 170, and the pressed section 1811 is connected to the elastic section 1812 and is away from the substrate 170. The support component 123 abuts against the pressed section 1811. In other words, the orthographic projection area P7 of the support component 123 in the X-axis direction is located on the pressed section 1811. Thus, the pressing part 121 can be prevented from interfering with the second actuation part 142 of the operation element 140 when moving in the pressing direction D1. Specifically, the elastic section 1812 can be slightly deformed when the pressed section 1811 is pressed by the support component 123, such that the first actuation part 122 can move in the pressing direction D1 without interfering with the second actuation part 142. In another aspect, the elastic section 1812 can push the support component 123 after the pressure applied to the pressed section 1811 is released, such that the pressing element 120a returns to the original position in the positive Z-axis direction. In one embodiment, the cantilever element 181 can be in a flat plate shape. Specifically, the pressed section 1811 and the elastic section 1812 can both extend substantially parallel to the surface 171. In addition, in the present embodiment, the cantilever element 181 and the substrate 170 can have a monolithic structure. For example, the cantilever element 181 can be formed by cutting from the substrate 170, but the specific manufacture procedure is not limited in the present disclosure.

FIG. 10 is a schematic diagram of a projection device in one embodiment of the present disclosure. FIG. 11 is a block diagram of the projection device in FIG. 10. Reference is made to FIG. 10 and FIG. 11. The projection device 200 includes a housing 210, a processing unit 220, a projection module 230, and the button module 100. In the present embodiment, the button module 100 in FIG. 1 is taken as an example for explanation. In other embodiments, the button module can be the button module 100a in FIG. 6 or the button module 100b in FIG. 8. The housing 210 has an opening O. The processing unit 220 is disposed in the housing 210 and is coupled to the button module 100. Reference is made to FIG. 1, FIG. 10, and FIG. 11 together. The processing unit 220 generates an actuation signal when the pressing part 121 of the pressing element 120 is pressed. The projection module 230 is disposed in the housing 210 and is coupled to the processing unit 220. The projection module 230 receives the actuation signal from the processing unit 220 and projects a display image onto a screen.

The housing 210 can accommodate the processing unit 220, the projection module 230, and at least part of the button module 100, and the pressing part 121 of the pressing element 120 and the driven part 141 of the operation element 140 can be exposed in the opening O. It is to be noted that, in the prior art, because the pressing part and the driven part are separated from each other, the housing needs to have at least two openings to expose the pressing part and the driven part. In contrast, in the present embodiment, because the driven part 141 penetrates the pressing part 121 to extend out, the housing 210 can expose the pressing part 121 and the driven part 141 together by having one opening O. Thus, the number of the openings O can be reduced, and therefore the appearance and manufacture procedure of the housing 210 can be simplified. Incidentally, the button module 100 can be fixed to the housing 210 by means of the frame body 150. Specifically, the frame body 150 can be fixed to the inner side surface of the housing 210 in a screwed-in or embedded manner, which is not limited in the present disclosure.

The processing unit 220 in the present embodiment includes, for example, a central processing unit or a microprocessor, the processing unit 220 can, for example, be composed of a single or a plurality of processing elements, but the present disclosure is not limited thereto. Reference is made to FIG. 2 and FIG. 11 together. In the present embodiment, the processing unit 220 can be electrically connected to the first electronic element 110 and the second electronic element 130 and generates a corresponding actuation signal when the first electronic element 110 and/or the second electronic element 130 are/is actuated, thereby triggering a corresponding function. For example, when the first electronic element 110 is actuated by the pressing element 120, the actuation signal generated by the processing unit 220 can be used for turning on or turning off the power source of the projection device 200. In other words, the pressing element 120 can be used as a power switch of the projection device 200. On the other hand, when the second electronic element 130 is actuated by the operation element 140, the actuation signal generated by the processing unit 220 can be used for turning on or turning off the microphone of the projection device 200. In other words, the operation element 140 can be used as a microphone switch of the projection device 200. It can be understood that the functions corresponding to the pressing element 120 and the operation element 140 are not limited to the above.

Reference is further made to FIG. 11. The projection module 230 in the present embodiment can be electrically connected to the processing unit 220 to execute the corresponding function according to the actuation signal from the button module 100. The projection module 230 can include an illumination system, a light valve, and a projection lens. Specifically, the illumination system can provide an illumination beam to the light valve, and the light valve can convert the illumination beam into an image beam. The projection lens is arranged on a transmission path of the image beam to project the image beam, thereby forming a corresponding display image on the screen. In the present embodiment, the actuation signal generated by the first electronic element 110 triggering the processing unit 220 can be transmitted to the illumination system to drive the illumination system to emit the illumination beam.

Incidentally, the illumination system can include an excitation light source and a wavelength conversion element. The excitation light source includes, for example, a light-emitting diode (LED) or a laser diode (LD), and the number of light-emitting diodes or laser diodes can be one or plural. For example, the light-emitting diodes (or laser diodes) can be arranged as a matrix when the number of light-emitting diodes (or laser diodes) is plural. In addition, the wavelength conversion element is disposed on a transmission path of an excitation beam to convert at least part of the excitation beam into a conversion beam.

The light valve 210 can include a digital micromirror device (DMD), a liquid crystal on silicon (LCoS), or a liquid crystal display (LCD), but is not limited thereto. In addition, the present embodiment does not limit the number of light valves. For example, the projection device 200 can adopt a single-chip liquid crystal display panel or three-chip liquid crystal display panel structure, but is not limited thereto.

The projection lens includes, for example, one or more optical lenses, and the refractive powers of the optical lenses may be the same or different from each other. For example, the optical lens may include various non-planar lenses such as biconcave lenses, biconvex lenses, meniscus lenses, convex-concave lenses, plano-convex lenses, and plano-concave lenses, or any combination of the above-mentioned non-planar lenses. On the other hand, the projection lens may also include a planar optical lens. The present disclosure does not limit the type and configuration of the projection lens.

Compared with the prior art, the projection device 200 in the present embodiment has the advantage of easiness of operation by adopting the button module 100. In addition, the projection device 200 in the present embodiment has simplified appearance and manufacture procedure. It can be understood that in other embodiments, the projection device 200 can adopt the button module 100a or the button module 100b. In summary, the button module in the present disclosure adopts a pressing element and an operation element, where the pressing element actuates the first electronic element in the pressing direction, and the operation element actuates the second electronic element in the operation direction. Specifically, the driven part of the operation element protrudes from the pressing part instead of being separated from the pressing part. Therefore, with regard to the present disclosure, the space required for the configuration of the button module can be greatly reduced, and the convenience of operation of the button module can be improved. The projection device in the present disclosure has the advantage of the easiness of operation by adopting the button module. In addition, the projection device in the present disclosure has a simplified appearance and manufacturing procedure.

The foregoing description of the preferred embodiment of the disclosure has been presented for purposes of illustration and description. It is not intended to be exhaustive or to limit the disclosure to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the disclosure and its best mode practical application, thereby to enable persons skilled in the art to understand the disclosure for various embodiments and with various modifications as are suited to the particular use or implementation contemplated. It is intended that the scope of the disclosure be defined by the claims appended hereto and their equivalents in which all terms are meant in their broadest reasonable sense unless otherwise indicated. Therefore, the term “the disclosure” is not necessary limited the claim scope to a specific embodiment, and the reference to particularly preferred exemplary embodiments of the disclosure does not imply a limitation on the disclosure, and no such limitation is to be inferred. The disclosure is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the disclosure. It should be appreciated that variations may be made in the embodiments described by persons skilled in the art without departing from the scope of the disclosure as defined by the following claims. Moreover, no element and component in the disclosure is intended to be dedicated to the public regardless of whether the element or component is explicitly recited in the following claims.

What is claimed is:

1. A button module, comprising a first electronic element, a pressing element, a second electronic element, and an operation element, wherein:
the pressing element comprises a pressing part and a first actuation part, the pressing part has a through-hole, the first electronic element and the second electronic element are disposed on a first side of the pressing part, the first actuation part is connected to the pressing part and protrudes from the pressing part toward the first electronic element, the pressing part is configured to move relative to the first electronic element in a pressing direction, and the pressing part drives the first actuation part to move when the pressing part moves, so that the first actuation part actuates the first electronic element; and
the operation element comprises a driven part and a second actuation part, the driven part extends from the through-hole of the pressing part toward a second side of the pressing part, the second side of the pressing part is opposite to the first side of the pressing part, the second actuation part is connected to the driven part and extends towards the first side of the pressing part, the second actuation part is connected to the second electronic element and is configured to actuate the second electronic element, the driven part is configured to move relative to the pressing part along the through-hole in an operation direction, the driven part drives the second actuation part to move when the driven part moves, so that the second actuation part actuates the second electronic element, and the operation direction is different from the pressing direction.

2. The button module according to claim 1, wherein the pressing part has a first surface and a second surface opposite to each other, the first surface faces the first side, the second surface faces the second side, the through-hole penetrates the pressing part and extends from the first surface to the second surface, the driven part protrudes from the through-hole and extends away from the second surface, the second actuation part is aligned to the through-hole, an orthographic projection area of the second actuation part on the first surface is greater than an orthographic projection area of the through-hole on the first surface, there is a gap between the second actuation part and the first surface, wherein the second actuation part does not interfere with the pressing part when the driven part moves to drive the second actuation part to move.

3. The button module according to claim 1, further comprising a substrate and a buffer element, wherein the substrate is disposed on the first side of the pressing part, and has a surface facing the first actuation part and the second actuation part, the first electronic element, the second electronic element, and the buffer element are disposed on the surface, the pressing element further has a support component, and the support component extends from the pressing part toward the buffer element and abuts the buffer element.

4. The button module according to claim 3, wherein on the surface of the substrate, the second electronic element is located between the first electronic element and the buffer element, and an orthographic projection area of the second actuation part on the surface is located between an orthographic projection area of the first actuation part on the surface and an orthographic projection area of the support component on the surface.

5. The button module according to claim 3, wherein the buffer element is a rubber element.

6. The button module according to claim 3, wherein the buffer element is a cantilever element, the cantilever element has a pressed section and an elastic section connected to each other, the elastic section is connected to the substrate, the pressed section is connected to the elastic section and is away from the substrate, and the support component abuts the pressed section.

7. The button module according to claim 3, wherein the support component and the pressing part have a monolithic structure.

8. The button module according to claim 1, wherein the pressing part has a first surface and a second surface opposite to each other, the first surface faces the first side, the second surface faces the second side, the through-hole penetrates the pressing part and extends from the first surface to the second surface, the driven part protrudes from the through-hole and extends away from the second surface, and the second surface has a protruding part.

9. The button module according to claim 8, wherein an orthographic projection area of the protruding part on the second surface at least partially overlaps an orthographic projection area of the first actuation part on the second surface.

10. The button module according to claim 1, further comprising a frame body and a rib part, wherein the frame body surrounds the pressing part, two end parts of the rib part are respectively connected to the frame body and the pressing part, and the pressing part drives the first actuation part to move relative to the frame body when the pressing part moves in the pressing direction.

11. A projection device, comprising a housing, a processing unit, a projection module, and a button module, wherein:
the housing has an opening;
the button module comprises a first electronic element, a pressing element, a second electronic element, and an operation element, the pressing element comprises a pressing part and a first actuation part, the pressing part has a through-hole, the first electronic element and the second electronic element are disposed on a first side of the pressing part, the first actuation part is connected to the pressing part and protrudes from the pressing part toward the first electronic element, the pressing part is configured to move relative to the first electronic element in a pressing direction, the pressing part drives the first actuation part to move when the pressing part moves, so that the first actuation part actuates the first electronic element, the operation element comprises a driven part and a second actuation part, the driven part extends from the through-hole toward a second side of the pressing part, the second side of the pressing part is opposite to the first side of the pressing part, the second actuation part is connected to the driven part and extends towards the first side of the pressing part, the second actuation part is connected to the second electronic element and is configured to actuate the second electronic element, the driven part is configured to move relative to the pressing part along the through-hole and in an operation direction, the driven part drives the second actuation part to move when the driven part moves, so that the second actuation part actuates the second electronic element, the operation direction is different from the pressing direction, and the pressing part and the driven part are located in the opening and are exposed in the opening;
the processing unit is disposed in the housing and is coupled to the button module, and the processing unit generates an actuation signal when the pressing part of the pressing element is pressed; and
the projection module is disposed in the housing and is coupled to the processing unit, and the projection module receives the actuation signal and projects to form an image on a screen.
